(19) United States
(12) Patent Application Publication
(10) Pub. No.: US 2015/0278937 A1
(43) Pub. Date: Oct. 1, 2015

(54) SYSTEMS AND METHODS OF PROVIDING KEY FIGURE INFORMATION

(71) Applicants: Markus Kahn, Keil am See (DE); Matthias Schwan, Heidelberg (DE); Dorothea Mayer, Sandhausen (DE); Hermann Haaf, Heidelberg (DE); Silvia Harmsen, Munchen (DE); Markus Fenn, Mannheim (DE); Silke Froese, Heidelberg (DE); Gernot Krause, Sandhausen (DE); Frank Raebiger, Bammental (DE); Dirk Endesfelder, Angelbachtal (DE)

(72) Inventors: Markus Kahn, Keil am See (DE); Matthias Schwan, Heidelberg (DE); Dorothea Mayer, Sandhausen (DE); Hermann Haaf, Heidelberg (DE); Silvia Harmsen, Munchen (DE); Markus Fenn, Mannheim (DE); Silke Froese, Heidelberg (DE); Gernot Krause, Sandhausen (DE); Frank Raebiger, Bammental (DE); Dirk Endesfelder, Angelbachtal (DE)

(21) Appl. No.: 14/231,153

(22) Filed: Mar. 31, 2014

(51) Int. Cl. G06Q 40/00

(52) U.S. Cl. CPC G06Q 40/00

(57) ABSTRACT

Systems and methods of providing information associated with a financial instrument via a computer network are provided. Such a method may include receiving, by at least one processing circuit, from a computing device, a request for obtaining key figures of the financial instrument. The request may include a data object comprising a first identifier identifying the financial instrument, a second identifier identifying an entity owning the financial instrument, a third identifier identifying a collection of specifications structuring a body of accounting records, a fourth identifier identifying a fiscal year, a fifth identifier identifying a category of the financial instrument, and a sixth identifier identifying at least one of a posting period and an accounting period. The method may further include determining values of the key figures of the financial instrument based on the data object, and providing the values of the key figures.

### BACKGROUND

The present disclosure relates generally to systems and methods for providing key figure information of a financial instrument.

Entities and individuals may own various financial instruments. A financial instrument can be any contract that gives rise to a financial asset of one entity and a financial liability or equity instrument of another entity. Examples of a financial instrument may include a checking account contract, a credit card contract, stocks, bonds, loans, etc. Because each type of financial instrument may have different attributes and characteristics, the task of obtaining data, such as values of balance key figures, of the financial instrument in an efficient and effective manner remains a challenge.

### SUMMARY

One aspect of an exemplary embodiment is directed to a computer-implemented method of providing information of a financial instrument via a computer network. The method includes receiving, by at least one processing circuit, a request for obtaining one or more key figures of the financial instrument via the computer network from a computing device. The request includes a data object including a first identifier identifying the financial instrument, a second identifier identifying an entity owning the financial instrument, a third identifier identifying a collection of specifications structuring a body of accounting records, a fourth identifier identifying a fiscal year, a fifth identifier identifying a category of the financial instrument, and a sixth identifier identifying a posting period or an accounting period. A starting date of the posting period or the accounting period is same or later than a starting date of the fiscal year, and an ending date of the posting period or the accounting period is same or earlier than an ending date of the fiscal year. The method further includes determining one or more values of the one or more key figures of the financial instrument based at least in part on the data object. The method also includes providing the one or more values of the one or more key figures of the financial instrument via the computing network to the computing device.

Another aspect of an exemplary embodiment is directed to a system for providing information of a financial instrument via a computer network. The system includes at least one processing circuit configured to receive a request for obtaining one or more key figures of the financial instrument via the computer network from a computing device. The request includes a data object comprising a first identifier identifying the financial instrument, a second identifier identifying an entity owning the financial instrument, a third identifier identifying a collection of specifications structuring a body of accounting records, a fourth identifier identifying a fiscal year, a fifth identifier identifying a category of the financial instrument, and a sixth identifier identifying a posting period or an accounting period. A starting date of the posting period or the accounting period is same or later than a starting date of the fiscal year, and an ending date of the posting period or the accounting period is same or earlier than an ending date of the fiscal year. The at least one processing circuit is further configured to determine one or more values of the one or more key figures of the financial instrument based at least in part on the data object. The at least one processing circuit is also configured to provide the one or more values of the one or more key figures of the financial instrument via the computing network to the computing device.

Another aspect of an exemplary embodiment is directed to a non-transitory computer readable medium having machine instructions stored therein, the instructions being executable by one or more processors to cause the one or more processors to perform operations. The operations include providing a data object associated with one or more key figures of a financial instrument. The data object includes a first identifier identifying the financial instrument, a second identifier identifying an entity owning the financial instrument, a third identifier identifying a collection of specifications structuring a body of accounting records, a fourth identifier identifying a fiscal year, a fifth identifier identifying a category of the financial instrument, and a sixth identifier identifying a posting period or an accounting period, wherein a starting date of the posting period or the accounting period is same or later than a starting date of the fiscal year, and an ending date of the posting period or the accounting period is same or earlier than an ending date of the fiscal year.

### BRIEF DESCRIPTION OF THE DRAWINGS

Various embodiments taught herein are illustrated by way of example, and not by way of limitation, in the figures of the accompanying drawings, in which:

FIG. 1 is a block diagram depicting an example system for providing information of a financial instrument via a computer network, according to an illustrative embodiment;

FIG. 2A depicts one implementation of an interface configured to receive inputs from a user at a computing device to generate a request for key figures of a financial instrument, according to an illustrative embodiment;

FIG. 2B illustrates an element structure for a query for requesting key figures of a financial instrument, according to an illustrative embodiment;

FIG. 3A depicts one implementation of an interface configured to display values of the key figures of an financial instrument as the result of a query, according to an illustrative embodiment;

FIG. 3B illustrates an element structure for a response generated for a query for requesting key figures of a financial instrument, according to an illustrative embodiment;

FIG. 4 is a block diagram depicting an example use case for providing information of a financial instrument using a web service via a computer network, according to an illustrative embodiment;

FIG. 5 is a block diagram depicting another example use case for providing information of a financial instrument by file exchange via a computer network, according to an illustrative embodiment;

FIG. 6 illustrates a flow diagram depicting a process of providing information of a financial instrument via a computer network, according to an illustrative embodiment;

FIG. 7 illustrates a more detailed block diagram of the computing device and the server in the system for providing information of a financial instrument, according to an illustrative embodiment; and

FIG. 8 illustrates an element structure for a financial instrument position account balance key figure, according to an illustrative embodiment.

### DETAILED DESCRIPTION

The more detailed descriptions of various concepts related to, and embodiments of, methods, systems, and tangible computer readable medium for providing information of a financial instrument are provided below. The disclosure is not limited to the details or methodology set forth in the descriptions or illustrated in the figures. Terminology is for the purpose of description only and should not be regarded as limiting.

Referring generally to the Figures, systems and methods for providing information of a financial instrument over a computer network are shown and described. Entities and individuals may own various financial instruments. According to International Accounting Standard (IAS), a financial instrument can be any contract that gives rise to a financial asset of one entity and a financial liability or equity instrument of another entity. Example of a financial instrument may include a checking account contract, a credit card contract, stocks, bonds, loans, etc. Because each type of financial instrument may have different attributes and characteristics, the task of obtaining data, such as values of balance key figures, of the financial instrument in an efficient and effective manner remains a challenge. Methods and systems described herein develop a data object which captures important attributes and characteristics of various financial instruments and can be used by computing systems to make valuations of the financial instruments in an efficient and effective manner.

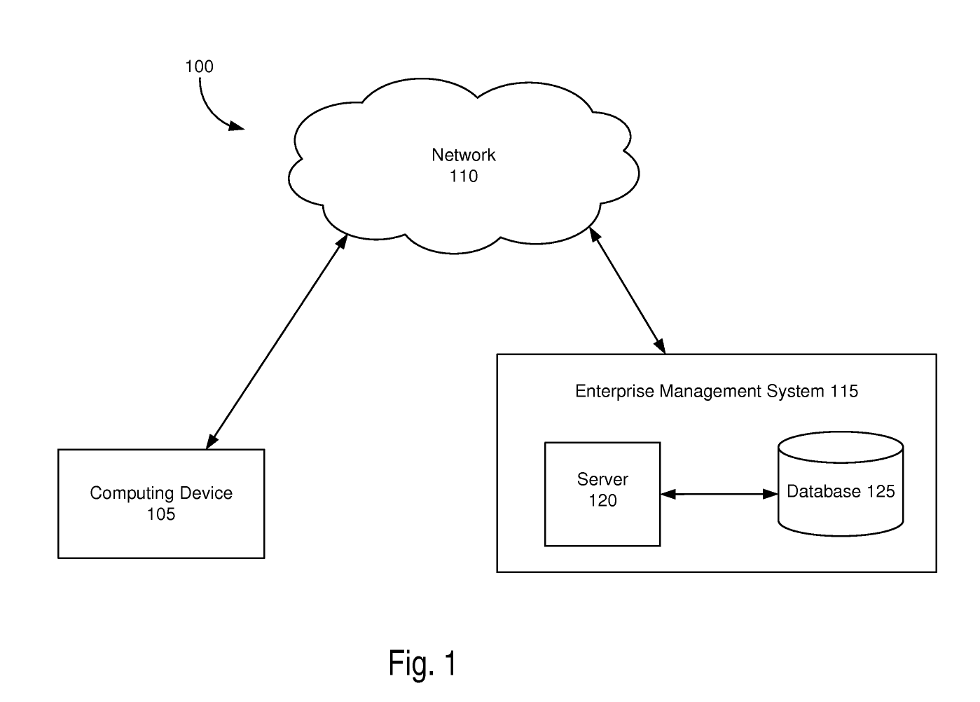

FIG. 1 is a block diagram depicting a system 100 for providing information of a financial instrument via a computer network 110. System 100 includes a computing device 105 which communicates with other computing devices via a network 110. For example, computing device 105 may communicate with one or more servers in an enterprise management system 115 (e.g., a bank's backend system). The computing device 105 may be a computing device outside of the entity that owns the enterprise management system 115, such as a customer of the bank. The computing device 105 may also be a computing device within the entity owning the enterprise management system 115, such as a computing device used by an accountant of the bank.

The computing device 105 can include at least a processor or processing circuit and memory. Computing device 105 may be a server, workstation computers, laptop, desktop, smart phone, tablet, or any other computing device upon which an appliance may be installed originally. The computing device 105 may execute software applications (e.g., financial accounting software, virtual desktop software, file transfer software, etc.) stored in memory of the computing device. The software applications can have communication interfaces (e.g., NICs) and send and receive data to and from other computing devices (e.g., server 120) over network 110. The computing device 105 may also communicate with other computing devices (e.g., server 120) using a web browser, for example, via a user interface that is displayed in the web browser.

Network 110 may be any form of data network that relays information between the computing device 105 and the server 120 of the enterprise management system 115 For example, network 110 may include the Internet and/or other types of data networks, such as a local area network (LAN), a wide area network (WAN), a cellular network, satellite network, etc. Network 110 may also include any number of computing devices (e.g., computer, servers, routers, network switches, etc.) that are configured to receive and/or transmit data within network 110. In other words, network 110 may include other devices configured to relay data between the computing device 105 and the server 120. Network 110 may include any number of hardwired and/or wireless connections. For example, the computing device 105 may communicate wirelessly (e.g., via WiFi, cellular, radio, etc.) with a transceiver that is hardwired (e.g., via a fiber optic cable, a CATS cable, etc.) to other devices in network 110. In addition to the computing device 105 and the server 120 of the enterprise management system 115, network 110 may be configured to relay data between any number of different computing devices.

The enterprise management system 115 can include at least one server, such as the server 120, and at least one database, such as the database 125. The server 120 can be computing devices having at least a processor or processing circuit and memory. The server 120 can include communication interfaces to receive and send data from other computing devices, such as the computing device 105, via the network 110. The server 120 can retrieve information from the database 125 and perform operations by executing software applications. In some embodiments, the server 120 can be a web server hosting a web site of the entity owning the enterprise management system 115 (e.g., a bank, an insurance company, etc.) and provide web services via the internet.

The database 125 can include data storage units or data structures for storing data such as financial instruments. The database 125 can be part of the enterprise management system 115 or can be outside of the enterprise management system 115 that the system 115 can access via the network 110. In some embodiments, the database 125 can be a cloud based database. The database 125 can be organized to facilitate search and retrieval of information contained within the database. Although only one database is shown in FIG. 1, a plurality of databases can be included in the enterprise management system 115.

In some embodiments, the server 120 can receive a request for obtaining one or more key figures of a financial instrument via the computer network 110 from a computing device. For example, a processing circuit of the server 120 can be configured to receive a request from the computing device 105 in an accounting workplace or impairment workplace. The request may indicate that the operators of the computing device 105 (e.g., an accountant or a customer) would like to read information of some key figures of a financial instrument. Non-limiting examples of key figures of financial instruments may include accounting balance key figures, financial instrument accounting balance sheet key figures, accounting profit and loss key figures, and calculation base key figures.

For example, an accounting balance key figure of a date can be the sum of all contributions of the key figure from the past up to this date. For instance, if period 1 produces an interest income of EUR 4, and period 2 produces an interest income of EUR 6, the balance of the interest income would be EUR 10. Financial instrument accounting balance sheet key figures can include, for example, receivables, accrued interest, and fair value adjustment, etc. Accounting profit and loss key figures can include, for instance, fees, profit and loss statement interest expense, and profit and loss statement result such as fair value adjustment, etc. Calculation base key figures can include, for example, free line of a current account contract, effective interest rate, etc.

The request received at the server 120 can include a data object including a plurality of attributes or elements that are important to the operations of the financial instruments. In some embodiments, the data object can include an identifier for identifying the financial instrument. The identifier can be unique. For example, a first checking account contract may have a unique identifier of SM-L659_{—}00000000, a second checking account contract may have a unique identifier of 89763, a deposition account contact may have a unique identifier of 23abcd89, a bond may have a unique identifier of LTR983700001, and so on. In various embodiments, the unique identifier can be generated randomly using a random number generator. For example, the unique identifier can be generated using a hash function based on an input string, such as the name of the financial instrument, for example, “Mortgage Loan X13C1”.

In some embodiments, the data object can include an identifier for identifying an entity owning the financial instrument. An entity can be a financially and legally independent, geographically unbound organization registered under business law. The identifier can be unique. For example, a bank owning the financial instrument may have a unique identifier of L659, and an insurance can have a unique identifier of 9834M. Similar to the unique identifier of the financial instrument, the unique identifier for the entity owning the financial instrument can be generated randomly using different methods in various implementations.

In some embodiments, the data object can include an identifier for identifying a collection of specifications structuring a body of accounting records. The body of accounting records may contain all data of all positions of a balance sheet and profit and loss statement. In one embodiment, the identifier is used to determine specific parameters for the calculation in the enterprise management system 115 and is generally associated with an accounting system.

In some embodiments, the data object can include an identifier for identifying a fiscal year. A fiscal year can be a period used for calculating annual financial statements in businesses and other organizations. For example, a fiscal year can be a specific period of time designated by a numerical year value for which the profit and loss of a company is regularly accounted (inventory and balance sheet). A fiscal year does not necessarily correspond to the calendar year. For example, a fiscal year can be from Feb. 1, 2014 to Jan. 31, 2015.

In some embodiments, the data object can include an identifier for identifying a category of the financial instrument. For example, a checking account contract is a different category than a bond.

In some embodiments, the data object can include an identifier for identifying a posting period or an accounting period. A posting period can be a period for which the key figures for the financial instrument are effective and can be based on multiple accounting documents that were posted before the ending date of the posting period. An accounting period can be a period within the fiscal year in which certain financial events took place. The starting date of the posting period or the accounting period can be same or later than the starting date of the fiscal year. The ending date of the posting period or the accounting period can be same or earlier than the ending date of the fiscal year.

In some embodiments, the request may include a message which includes a message header and a payload, and the payload includes the data object. For example, the data object can be encapsulated in the payload of the message. In some embodiments, the message can be generated based on a web service definition in Web Services Description Language (WSDL). In some embodiments, the message can be generated by application software at the computing device 105 upon a user of the computing device entering a set of values to a user interface.

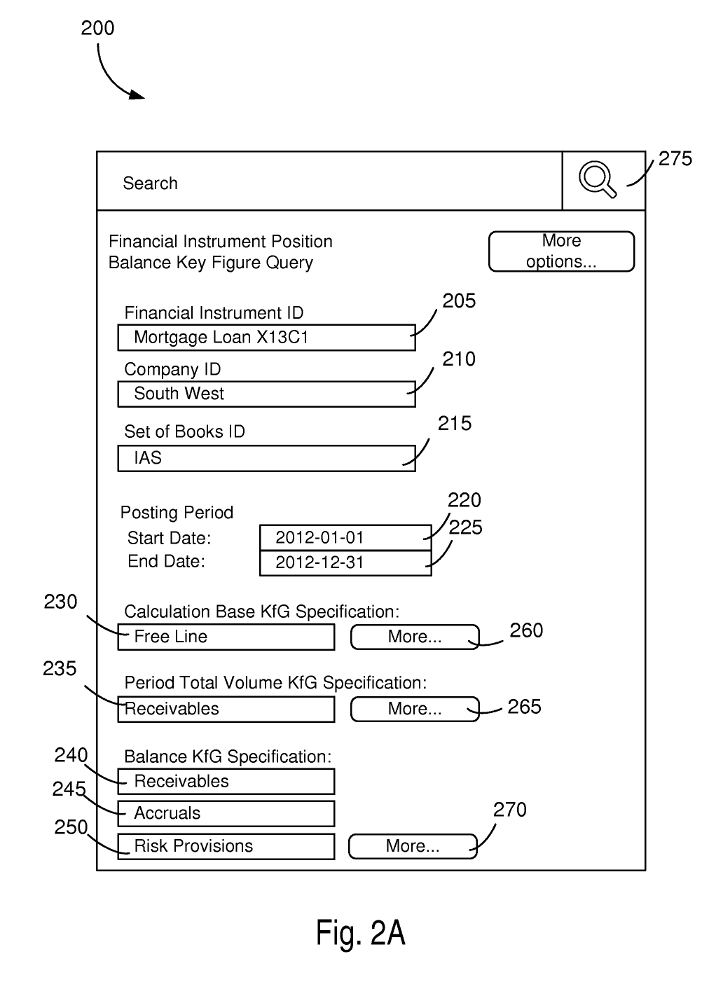

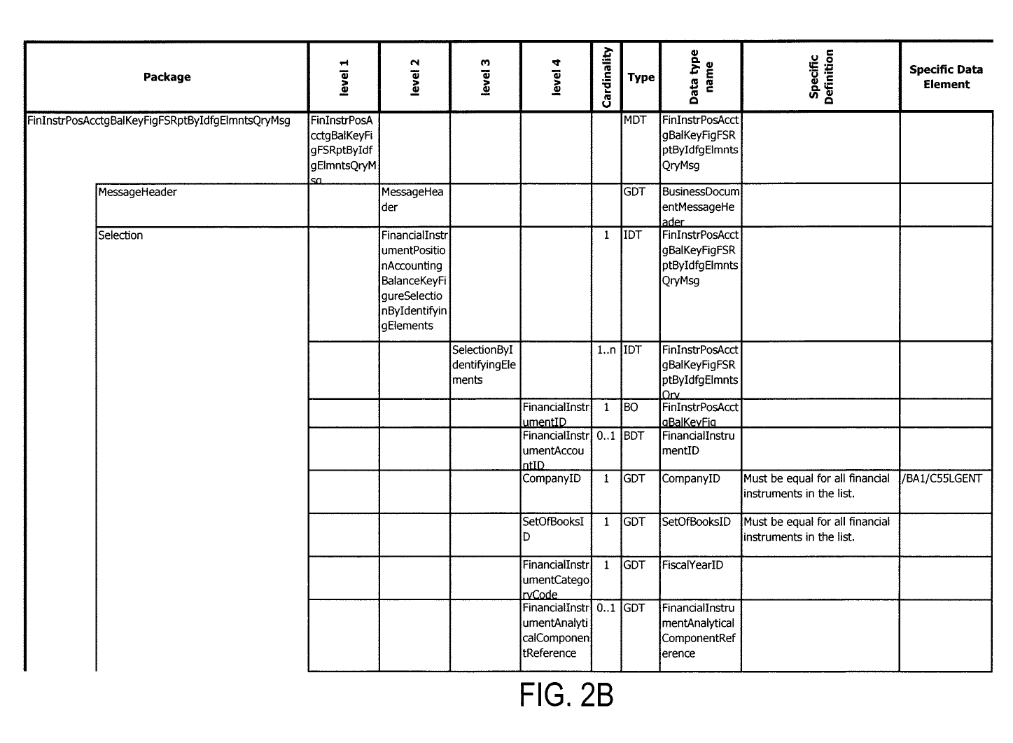

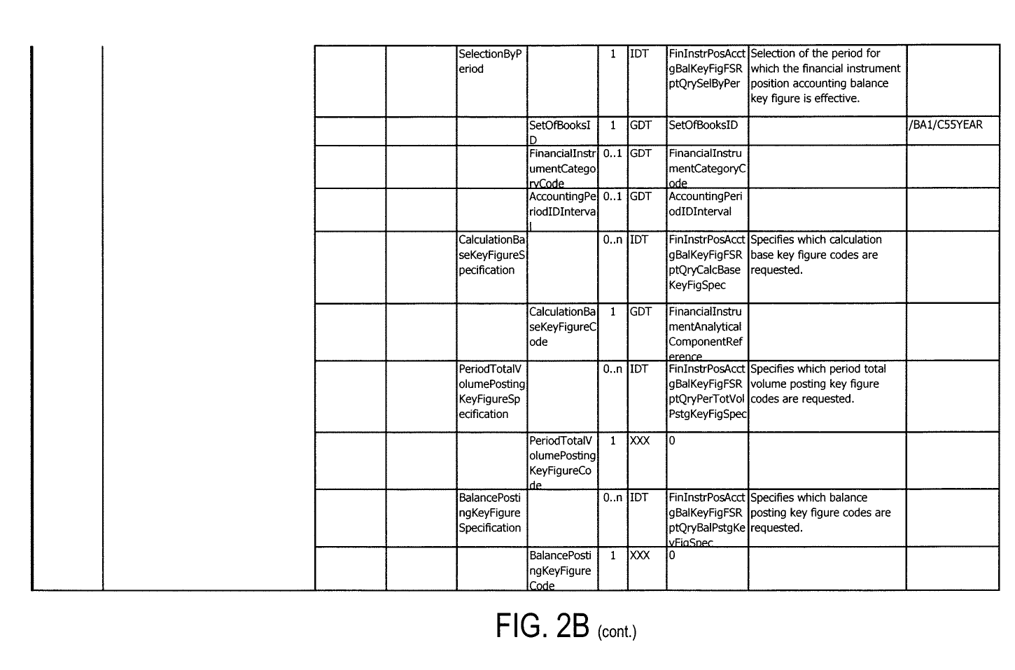

FIG. 2A depicts one implementation of an interface 200 configured to receive inputs from a user at the computing device 105 to generate a request for key figures of a financial instrument. User interface 200 may be part of an application running locally on the computing device 105, or a web-based application, or some combinations of a web-based application and a local application.

Referring to FIG. 2A, exemplary user interface 200 includes a financial instrument ID field 205 for the user to input the financial instrument, a company ID field 210 for the user to input an entity owning the financial statement, a set of books ID field 215 for the user to enter a collection of specifications structuring a body of accounting records, and posting period fields 220, 225 for the user to enter a posting period. The user interface 200 may also include one or more key figure specifications fields for the user to enter what key figures that user intends to receive. As shown in the exemplary user interface 200, a calculation base key figure specification field 230, a period total volume key figure specification field 235, and balance key figure specification fields 240, 245, and 250 are shown. Some or all of these fields illustrated in the user interface 200 can be included in the data object that is sent from the computing device 105 to the server 120.

The exemplary user interface 200 may also include a search button 275, which when clicked, can generate a request for obtaining values of the key figures indicated in the key figure specifications. User interface 200 may also include a plurality of buttons 260, 265, 270 that when clicked, can display additional information associated with the field next to it. For example, when the button 260 is clicked, additional calculation base key figure specification fields, such as an effective interest rate field, can be displayed. It should be noted that user interface 200 is one example of generating a request for key figures of a financial instrument. More, less, or different fields than those shown in FIG. 2A and different layouts of the interface can be utilized.

In some embodiments, the data object can be stored and transmitted using an Extensible Markup Language (XML) document. For example, the computing device 105 can generate an XML document which includes the attributes of the data object based on the user inputs to the user interface 200. In other embodiments, the data object can be stored and transmitted using other formats.

Referring now to FIG. 2B, an element structure is illustrated for a query for requesting key figures of a financial instrument. Using information received at the user interface 200 of FIG. 2A, an element structure is built for the query that includes fields for values specified by the user at user interface 200. The element structure is shown to include various data types as described in the present disclosure. The element structure is provided to the server 120.

For example, in the embodiment of FIG. 2B, the element includes a message including the message header and the selection (e.g., the “body” of the message). The selection is shown to include an identification information attribute that may include attributes such as a financial instrument ID, company ID, or a set of books ID as specified by the user in fields 205, 210, 215 of user interface 200. The attributes may further include identifying elements such as a financial instrument category code or other values that may be automatically determined or deduced based on the user input (e.g., a code associated with a company that was specified by the user in field 210).

The selection is shown to further include a posting period information attribute that may include attributes such as a fiscal year ID and a posting period. Such information may be provided by the user of user interface 200 (e.g., via fields 220, 225 for specifying a posting period) or may be determined based on the user input (e.g., determining a length of period of time based on the start date and end date provided by the user).

The selection is shown to further include a calculation base key figure specification attribute (including information provided via field 230), a period total volume specification attribute (including information provided via field 235), and a balance specification attribute (including information provided via fields 240, 245, 250). As shown, each attribute may have any cardinality and be of any data type.

Referring back to FIG. 1, in some embodiments, the server 120 can determine the values of the key figures of the financial instrument based at least in part on the attributes in the data objects. For example, a processing circuit of the server 120 can be configured to determine the values of the key figures of the financial instrument. In one embodiment, the server 120 retrieves information associated with the financial instrument from a database based on the data object. For example, the server 120 can query the database 125 by specifying the attributes in the data object. For example, the query can include the identifier of the financial instrument, the identifier of the entity owning the financial instrument, the posting period and other attributes of the data object as described herein.

In some embodiments, the server 120 can determine the values of the key figures of the financial instrument based on the information retrieved from the database. For example, if the key figure requested is an accounting balance key figure for a mortgage loan at Dec. 31, 2013, the balance of the mortgage loan at Dec. 31, 2013 can be calculated.

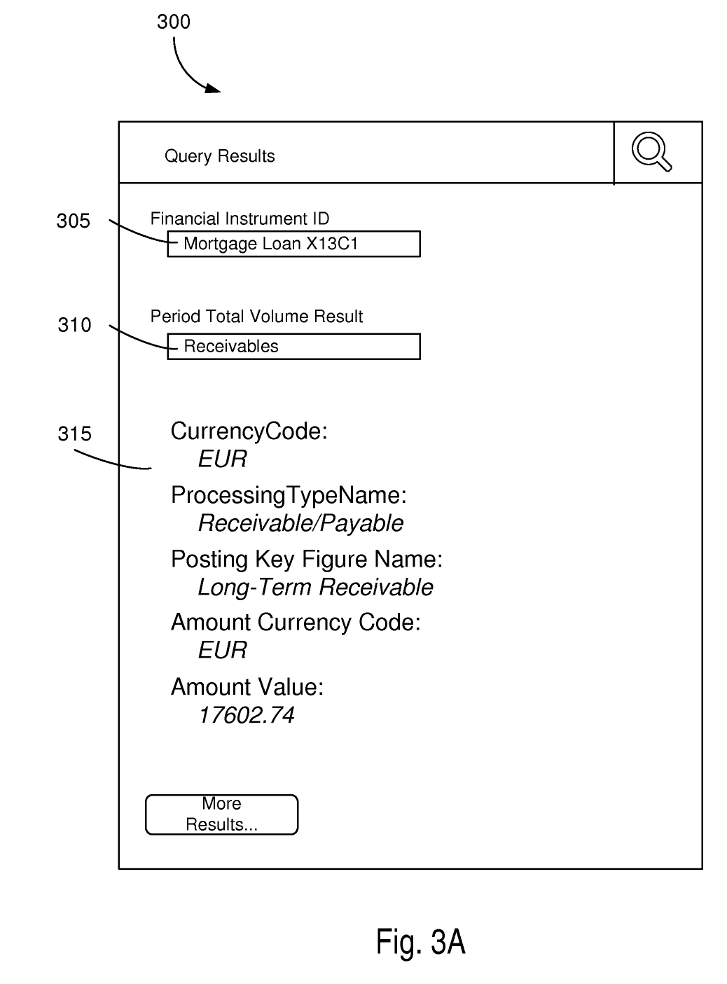

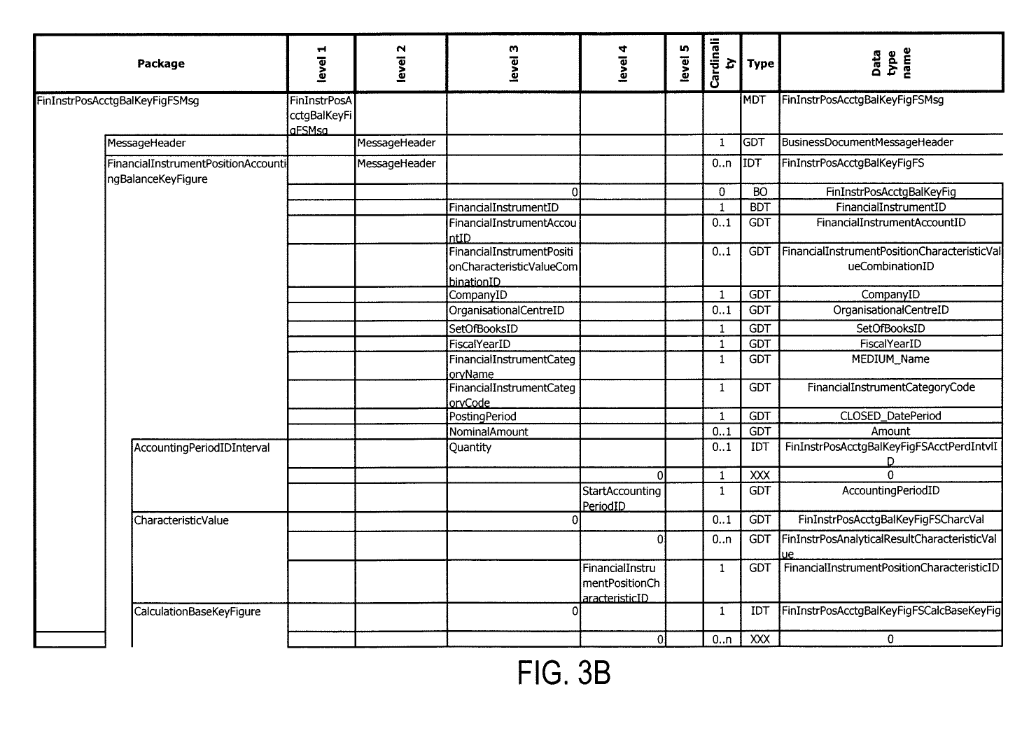

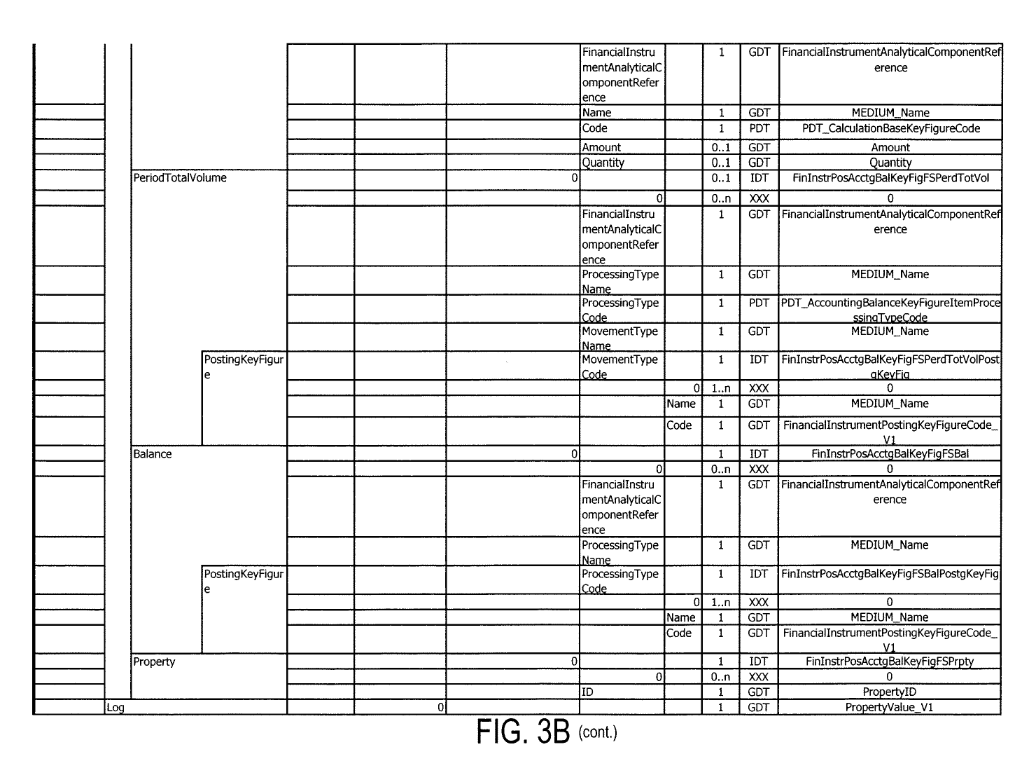

In some embodiments, the server 120 can provide the values of the key figures of the financial instrument determined via the computing network 110 to the computing device 105. For example, a processing circuit of the server 120 can be configured to provide the values of the key figures to the computing device 105. In some embodiments, the values of the key figures can be embedded in a data object as described here. In some embodiments, the server 120 can generate an XML document which includes the values of the key figures determined by the server 120. The XML document can be transmitted to the computing device 105 via the network 110. In some embodiments, the values can be included in a response message of a web service. The response message can include a header and a payload. The payload can include the values of the key figures in the format of the data object. The values of the key figures can be returned to the computing device 105 and displayed in an user interface, such as the user interface illustrated in FIG. 3A.

FIG. 3A depicts one implementation of an interface 300 configured to display values of the key figures of a financial instrument as the result of a query. Similar to user interface 200, the user interface 300 may be part of an application running locally on the computing device 105, or a web-based application, or some combinations of a web-based application and a local application. As shown in the user interface 300, a financial instrument ID field 305 displays the financial instrument associated with the query result. A field 310 displays the key figure associated with the query result. In the example of the user interface 300, the key figure is receivables of period total volume. An area 315 in the user interface 300 displays the values of the key figure which is displayed in field 310.

In various embodiments, the data object may include additional attributes. The data object may include a characteristic value element which may include a financial instrument position characteristic identifier for identifying a financial instrument position characteristic, and a financial instrument position characteristic value associated with the financial instrument position characteristic identifier.

In some embodiments, the data object may include a calculation base key figure element. The calculation base key figure is determined with respect to the end date of the posting period. The calculation base key figure element may include a financial instrument analytical component reference representing a reference to an analytical view on the financial instrument. In general, this component is made at the issuance of a financial instrument and is not revised for subsequent changes in market interest rates, share prices, or other events that change the likelihood that an option included in the financial instrument will be exercised. The calculation base key figure element may also include a calculation base code indicating a calculation base key figure with a user defined code list. For example, a code of 0001 may indicate open line of a current account. The calculation base key figure element may further include at least one of an amount of a calculation base key figure, a quantity of a calculation based key figure, and a decimal value of a calculation base key figure.

In some embodiments, the data object may include a period total volume of a financial instrument position accounting balance key figure which may further include a financial instrument analytical component reference representing a reference to an analytical view on the financial instrument. Similar to the financial instrument analytical component reference of the calculation base key figure element, in general, this component is made at the issuance of a financial instrument and is not revised for subsequent changes in market interest rates, share prices, or other events that change the likelihood that an option included in the financial instrument will be exercised. The period total volume of a financial instrument position accounting balance key figure may also include a processing type code indicating a processing type of an accounting balance key figure item, a movement type code indicating a coded representation of a type of movement on a leger, and a posting key figure for a period total volume of a financial instrument position.

In some embodiments, the data object may include a balance element indicating a posting key figure for an accounting balance of a financial instrument position. The balance element may include a financial instrument analytical component reference representing a reference to an analytical view on the financial instrument. Similar to the financial instrument analytical component reference of the calculation base key figure element, in general, this component is made at the issuance of a financial instrument and is not revised for subsequent changes in market interest rates, share prices, or other events that change the likelihood that an option included in the financial instrument will be exercised. The balance element may also include a processing type code indicating a processing type of an accounting balance key figure item, and a posting key figure for a financial instrument position.

In some embodiments, the data object may include a property element indicating additional characteristics and key figures on a header level of the financial instrument position accounting balance key figure. The property element may include an identifier for identifying a property and a property value describing a value that can be assigned to a property.

In some embodiments, the data object may include a financial instrument account identifier for identifying an account for a financial instrument. The data object may include a financial instrument position characteristic value combination identifier for identifying a characteristic value combination of a financial instrument position. The data object may include an organization center identifier for identifying an origination unit responsible for the contribution of the financial instrument. The data object may include a nominal amount element indicating an amount with a corresponding currency unit of a position of the financial instrument. The data object may include a quantity element indicating a non-monetary numerical specification of an amount in a unit of measurement of the financial instrument.

The attributes and elements of the data object described herein are examples. More, less, or different attributes and elements may be included in the data object in accordance with various implementations. The data object described herein can be used in various contexts for carrying and transfer data. For example, the data object can be used in a web service context using a WSDL definition. The data object can also be used in other contexts, for example, a RESTful service, a file exchange context, etc.

Referring now to FIG. 3B, an element structure is illustrated for a response generated for a query for requesting key figures of a financial instrument. The information in the response may be formatted and used in the user interface 300. The element structure of FIG. 3B is shown to include various data types as described in the present disclosure.

For example, in the embodiment of FIG. 3B, the element includes a message including the message header and the financial instrument position accounting balance key figure. The financial instrument position accounting balance key figure includes various attributes to be displayed on user interface 300. For example, the attributes may include identification information such as a financial instrument ID, financial instrument account ID, company ID, set of books ID, or any other identification. As shown in user interface 300, the financial instrument ID may be retrieved for display (in field 305) from the element.

The attributes may further include an accounting period ID interval, indicating a start time and end time for the period of time indicated by the user in the query. The attributes may further include any characteristic value or calculation base key figure.

The attributes may further include a period total volume attribute representing a reference to an analytical view on the financial instrument. For example, referring to field 310 of user interface 300, the period total volume attribute may be retrieved from the element and displayed (“receivables”).

The attributes may further include a balance attribute. The balance attribute may be used to, for example, fill out field 315 of user interface 300 with relevant information relating to the query. For example, the currency code, processing type name, posting key figure name, amount currency code, and amount value attributes may be retrieved from the balance attribute of the element of FIG. 3B.

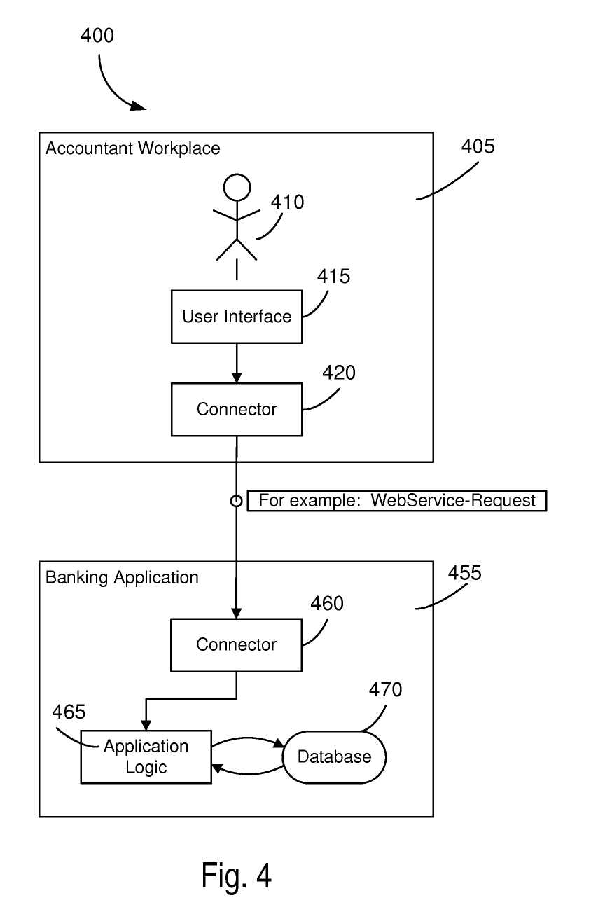

FIG. 4 is a block diagram depicting an example use case 400 for providing information of a financial instrument using a web service via a computer network. Referring to FIG. 4, in an accounting workplace 405, a user 410 (e.g., an accountant) may operate a computing device (e.g., 105 in FIG. 1) to request key figure information of a financial instrument. For example, user 410 may input the attributes of the request via a user interface 415. The user interface 415 can be a user interface such as the user interface 200 in FIG. 2 or can be a different user interface. In some embodiments, the user interface 415 can be a web-based application configured to make a web service request and can be executed by a web browser. The web service request can include the data object, as described herein. A connector 420 can be any communication connections for relaying the information received by the user interface 415 to another computing device, such as the server 120 of the enterprise management system 115 in FIG. 1. The connector 420 can communicate with another connector 460 using network protocols, for example Hypertext Transfer Protocol (HTTP), to transfer data via the internet.

Referring to FIG. 4, banking application 455 can be any application including hardware and software embodied in a tangible medium for receiving the web service request and returning the requested financial instrument key figure information to the computing device that the user 410 operates. In some embodiments, the banking application 455 can be hosted by a web server for providing a web service. The web service can receive a service request and return the information that the request is asking for. The connector 460 can be a communication connection similar to the connector 420 configured to receive the web service request using the same network protocols that the connector 420 uses. Application logic 465 can include any application configured to retrieve information associated with the financial instrument and determine the values of the key figures of the financial instrument. For example, application logic 465 can include a module configured to retrieve the information from a database 470. For example, application logic 465 can include a module configured to determine the values of the financial instrument by performing calculations according to accounting standards. Database 470 can store information of the financial instrument and can be the database 125 in FIG. 1.

In some embodiments, the web service described herein for obtaining financial instrument key figure information can be defined by the WSDL. WSDL is written in XML format for describing network services as a set of endpoints operating on messages containing either document-oriented or procedure-oriented information. The web service definition of the web service can be created based on the data object as described herein. One exemplary implementation of the WSDL is shown below:

```
<xsd:complexType name= “FinInstrPosAcctgBalKeyFigFS”>
  <xsd:sequence>
    <xsd:element name= “ReferenceObjectNodeSenderTechnicalID” minOccurs= “0” type=
“ObjectNodePartyTechnicalID”/>
    <xsd:element name= “FinancialInstrumentID” type= “FinancialInstrumentID”/>
    <xsd:element name= “FinancialInstrumentAccountID” minOccurs= “0” type=
“FinancialInstrumentAccountID”/>
    <xsd:element name= “FinancialInstrumentPositionCharacteristicValueCombinationID” minOccurs= “0”
type= “FinancialInstrumentPositionCharacteristicValueCombinationID”/>
    <xsd:element name= “CompanyID” type= “CompanyID”/>
    <xsd:element name= “OrganisationalCentreID” minOccurs= “0” type= “OrganisationalCentreID”/>
    <xsd:element name= “SetOfBooksID” type= “SetOfBooksID”/>
    <xsd:element name= “FiscalYearID” type= “FiscalYearID”/>
    <xsd:element name= “FinancialInstrumentCategoryCode” type= “FinancialInstrumentCategoryCode”/>
    <xsd:element name= “FinancialInstrumentCategoryName” type= “LONG_Name”/>
    <xsd:element name= “PostingPeriod” type= “CLOSED_DatePeriod”/>
    <xsd:element name= “NominalAmount” minOccurs= “0” type= “Amount”/>
    <xsd:element name= “Quantity” minOccurs= “0” type= “Quantity”/>
    <xsd:element name= “AccountingPeriodIDInterval” type=
“FinInstrPosAcctgBalKeyFigFSAcctPerdIntvlID”/>
    <xsd:element name= “CharacteristicValue” minOccurs= “0” maxOccurs= “unbounded” type=
“FinInstrPosAcctgBalKeyFigFSCharcVal”/>
    <xsd:element name= “CalculationBaseKeyFigure” minOccurs= “0” maxOccurs= “unbounded” type=
“FinInstrPosAcctgBalKeyFigFSCalcBaseKeyFig”/>
    <xsd:element name= “PeriodTotalVolume” minOccurs= “0” maxOccurs= “unbounded” type=
“FinInstrPosAcctgBalKeyFigFSPerdTotVol”/>
    <xsd:element name= “Balance” minOccurs= “0” maxOccurs= “unbounded” type=
“FinInstrPosAcctgBalKeyFigFSBal”/>
    <xsd:element name= “Property” minOccurs= “0” maxOccurs= “unbounded” type=
“FinInstrPosAcctgBalKeyFigFSPrpty”/>
  </xsd:sequence>
</xsd:complexType>
```

In the example above, the name of the data object is “FinInstrPosAcctgBalKeyFigFS”, as defined by the xsd:complexType tag. The WSDL document can include one or more data objects. As shown above, the definition includes the attributes of the data object, defined by the xsd:element name tag. By way of example, the identifier for identifying the financial instrument is shown as “FinancialInstrumentID”, the identifier for identifying an entity owning the financial instrument is shown as “CompanyID”, and the identifier for identifying a collection of specifications structuring a body of accounting records is shown as “SetOfBookslD”. Continuing with the example, the identifier for identifying a fiscal year is shown as “FiscalYearID”, the identifier for identifying a category of the financial instrument is shown as “FinanciallnstrumentCategoryCode”, and the identifier for identifying a posting period is shown as “PostingPeriod”.

In some embodiments, request and response messages can be generated and passed between the client (e.g., the computing device 105 in FIG. 1 or the account workplace 405 in FIG. 4) and the server (e.g., the server 120 in FIG. 1 and the server hosting the banking application 455) to transfer data in the web service. The WSDL of the web service can define the message types of the request and response messages. The following exemplary XML code contained in an exemplary WSDL illustrates the definitions of the request and response messages for the web service providing financial instrument key figures.

```
<wsdl:message
name=“FinancialInstrumentPositionAccountingBalanceKeyFigureFSReportByIdentifyingElementsQuery”>
<wsdl:part
name=“FinancialInstrumentPositionAccountingBalanceKeyFigureFSReportByIdentifyingElementsQuery”
element=“n1:FinancialInstrumentPositionAccountingBalanceKeyFigureFSReportByIdentifyingElementsQuery”
/> </wsdl:message>
<wsdl:message
name=“FinancialInstrumentPositionAccountingBalanceKeyFigureFSReportByIdentifyingElementsResponse”>
  <wsdl:part
name=“FinancialInstrumentPositionAccountingBalanceKeyFigureFSReportByIdentifyingElementsResponse”
element=“n1:FinancialInstrumentPositionAccountingBalanceKeyFigureFSReportByIdentifyingElementsResponse”/>
</wsdl:message>
<wsdl:message name=“StandardMessageFault”>
  <wsdl:part name=“StandardMessageFault” element=“n1: StandardMessageFault”/>
</wsdl:message>
```

The above portion of WSDL shows three messages defined. A first message of “FinancialInstrumentPositionAccountingBalanceKeyFigureFSReportByIdentifyingElements Query”, a second message of “FinancialInstrumentPositionAccountingBalanceKeyFigureFSReportByIdentifyingElements Response”, and a third message of “StandardMessageFault” are illustrated. In one embodiment, the first message is a request message, the second message is a response message, and the third message is an error message. The error message is returned when there is an error in the operation. In some embodiments, main error messages can be recorded in a log of the response message. Examples of main error messages can include:

DCE.VME: Value Mapping Error

FOE.SVE: Schema Violation Error

PRE: Processing Error

PRE.IDE: Identification Error

The request and response messages can be generated based on the message types defined in the WSDL file. Below is an exemplary web service request message in XML format. As show in the example below, the “FinancialInstrumentPositionAccountingBalanceKeyFigureFSReportByIdentifyingElements Query” matches the request message (the first message) in the exemplary WSDL as described above. The request message below contains the data object as described herein. For example, the identifier for the financial instrument is shown as SM-L659_{—}00000000, which is between the <FinanciallnstrumentlD> tags. The identifier for the entity owning the financial instrument is shown as L659, which is between the <CompanyID> tags. The identifier for the collection of specifications structuring a body of accounting records is shown as IAS, which is between the <SetOfBooksID> tags.

```
<n0:FinancialInstrumentPositionAccountingBalanceKeyFigureFSReportByIdentifyingElementsQuery
xmlns:n0=“http://example.com/xi/Global20/Global”>
<MessageHeader>
  <UUID>2233ed04-5407-1ddd-bdd6-b67e4ddb8855</UUID>
  <CreationDateTime>2014-02-09T14:26:56.1234567Z</CreationDateTime>
  <TestDataIndicator>true</TestDataIndicator>
  <ReconciliationIndicator>true</ReconciliationIndicator>
  <SenderBusinessSystemID>TMK_001</SenderBusinessSystemID>
  </MessageHeader>
FinancialInstrumentPositionAccountingBalanceKeyFigureSelectionByIdentifyingElements>
<SelectionByIDentifyingElements>
  <FinancialInstrumentID>SM-L659_00000000</FinancialInstrumentID>
  <CompanyID>L659</CompanyID>
  <SetOfBooksID>IAS</SetOfBooksID>
  <FinancialInstrumentCategoryCode>2</FinancialInstrumentCategoryCode>
  </SelectionByIDentifyingElements>
<SelectionByPeriod>
  <FiscalYearID>2009</FiscalYearID>
<PostingPeriod>
<StartDate>2009-01-01</StartDate>
  <EndDate>2009-01-31</EndDate>
</PostingPeriod>
</SelectionByPeriod>
<CalculationBaseKeyFigureSpecification>
  <CalculationBaseKeyFigureCode>&62FRLIN</CalculationBaseKeyFigureCode>
  </CalculationBaseKeyFigureSpecification>
<CalculationBaseKeyFigureSpecification>
  <CalculationBaseKeyFigureCode>&55BVPDO</CalculationBaseKeyFigureCode>
  </CalculationBaseKeyFigureSpecification>
<CalculationBaseKeyFigureSpecification>
  <CalculationBaseKeyFigureCode>&71OFFCT</CalculationBaseKeyFigureCode>
  </CalculationBaseKeyFigureSpecification>
<BalancePostingKeyFigureSpecification>
  <BalancePostingKeyFigureCode>_KOPIIA</BalancePostingKeyFigureCode>
  </BalancePostingKeyFigureSpecification>
<BalancePostingKeyFigureSpecification>
  <BalancePostingKeyFigureCode>_KOACIN</BalancePostingKeyFigureCode>
  </BalancePostingKeyFigureSpecification>
<BalancePostingKeyFigureSpecification>
  <BalancePostingKeyFigureCode>_KORELT</BalancePostingKeyFigureCode>
  </BalancePostingKeyFigureSpecification>
<BalancePostingKeyFigureSpecification>
  <BalancePostingKeyFigureCode>_KAPRIR</BalancePostingKeyFigureCode>
  </BalancePostingKeyFigureSpecification>
<PeriodTotalVolumePostingKeyFigureSpecification>
<PeriodTotalVolumePostingKeyFigureCode>_KOPIIA</PeriodTotalVolumePostingKeyFigureCode>
  </PeriodTotalVolumePostingKeyFigureSpecification>
<PeriodTotalVolumePostingKeyFigureSpecification>
<PeriodTotalVolumePostingKeyFigureCode>_KOACIN</PeriodTotalVolumePostingKeyFigureCode>
  </PeriodTotalVolumePostingKeyFigureSpecification>
<PeriodTotalVolumePostingKeyFigureSpecification>
<PeriodTotalVolumePostingKeyFigureCode>_KORELT</PeriodTotalVolumePostingKeyFigureCode>
  </PeriodTotalVolumePostingKeyFigureSpecification>
  <PeriodTotalVolumePostingKeyFigureSpecification>
<PeriodTotalVolumePostingKeyFigureCode>_KAPRIR</PeriodTotalVolumePostingKeyFigureCode>
  </PeriodTotalVolumePostingKeyFigureSpecification>
</FinancialInstrumentPositionAccountingBalanceKeyFigureSelectionByIdentifyingElements>
</n0:FinancialInstrumentPositionAccountingBalanceKeyFigureFSReportByIdentifyingElementsQuery>
```

A portion of an exemplary web service response message in XML format is illustrated below. As show in the example below, the “FinancialInstrumentPositionAccountingBalanceKeyFigureFSReportByIdentifyingElements Response” matches the response message (the second message) in the exemplary WSDL as described above. The request message below contains the data object as described herein. For example, the identifier for the financial instrument is shown as SM-L659_{—}00000000, which is between the <FinanciallnstrumentID> tags. The identifier for the entity owning the financial instrument is shown as L659, which is between the <CompanyID> tags. The identifier for the collection of specifications structuring a body of accounting records is shown as IAS, which is between the <SetOfBooksID> tags. The values of the key figures of the financial instrument are shown below. For example, the balance element of the data object is shown between the <Balance> tags. As shown, the balance element includes a financial instrument analytical component reference “<FinanciallnstrumentAnalyticalComponentReference>”, a processing type code “<ProcessingTypeCode>”, and a posting key figure “<PostingKeyFigure>”, each of them includes additional fields. For example, the posting key figure includes a value of 11.29 EUR which is shown between the <Value><Amount> tags. In one embodiments, all the available information associated with the data object can be returned.

```
<n0:FinancialInstrumentPositionAccountingBalanceKeyFigureFSReportByIdentifyingElementsResponse
xmlns:n0=“http://example.com/xi/Global20/Global”
xmlns:prx=“urn:example.com:proxy:F5A:/1SAI/TAE1C3AEC7F7F5CB116453E:740”>
  <MessageHeader>
  <ID>0090FA0D8DA21EE3A1826608F6EBD249</ID>
  <UUID>0090fa0d-8da2-1ee3-a182-6608f6ebd249</UUID>
  <ReferenceUUID>2233ed04-5407-1ddd-bdd6-b67e4ddb8855</ReferenceUUID>
  <CreationDateTime>2014-02-23T09:46:11.678964Z</CreationDateTime>
  <SenderBusinessSystemID>F5A_821</SenderBusinessSystemID>
  <RecipientBusinessSystemID>TMK_001</RecipientBusinessSystemID>
  </MessageHeader>
  <FinancialInstrumentPositionAccountingBalanceKeyFigure>
  <FinancialInstrumentID>SM-L659_00000000</FinancialInstrumentID>
<FinancialInstrumentPositionCharacteristicValueCombinationID>rxy{O8CX7kA1o00MFgSXF0</
FinancialInstrumentPositionCharacteristicValueCombinationID>
  <CompanyID>L659</CompanyID>
  <SetOfBooksID>IAS</SetOfBooksID>
  <FiscalYearID>2009</FiscalYearID>
  <FinancialInstrumentCategoryCode>2</FinancialInstrumentCategoryCode>
  <FinancialInstrumentCategoryName>Financial Transaction</FinancialInstrumentCategoryName>
  <PostingPeriod>
  <StartDate>2009-01-01</StartDate>
  <EndDate>2009-01-31</EndDate>
  </PostingPeriod>
. . .
<Balance>
<FinancialInstrumentAnalyticalComponentReference>
  <ID>00001</ID>
  <TypeCode>1</TypeCode>
  <CurrencyCode>EUR</CurrencyCode>
  </FinancialInstrumentAnalyticalComponentReference>
  <ProcessingTypeCode>1BF_ACCR</ProcessingTypeCode>
  <ProcessingTypeName>[Operational] Accruals</ProcessingTypeName>
<PostingKeyFigure>
  <Code>_KOACIN</Code>
  <Name>Accruals: Interest Accruals</Name>
<Value>
  <Amount currencyCode=“EUR”>11.29</Amount>
  </Value>
  </PostingKeyFigure>
  </Balance>
....
  </FinancialInstrumentPositionAccountingBalanceKeyFigure>
<Log>
  <BusinessDocumentProcessingResultCode>3</BusinessDocumentProcessingResultCode>
  </Log>
  </n0:FinancialInstrumentPositionAccountingBalanceKeyFigureFSReportByIdentifyingElementsResponse>
```

In some embodiments, the user must have the authorization to execute a web service operation. For example, in the server side's back-end system, the following authorization objects can be checked: F_BAHW_RES and F_BAF1_AUG.

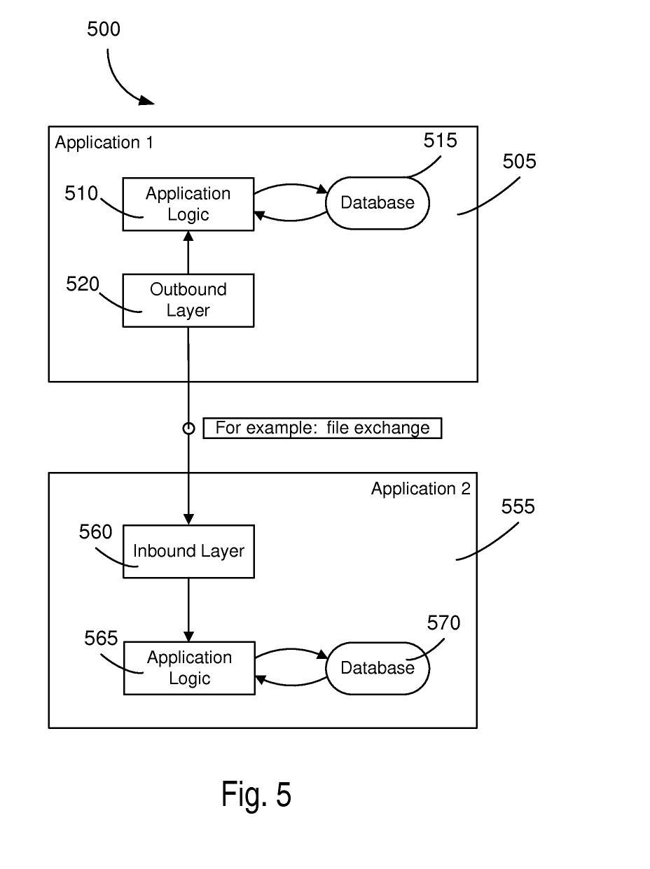

FIG. 5 is a block diagram depicting another example use case 500 for providing information of a financial instrument by file exchange via a computer network. Referring to FIG. 5, a first application 505 can exchange file with a second application 555. The file structure (e.g., an XML document) can be based on the data object as described herein. Application logic 510, 565 can be configured to retrieve information associated with a financial instrument from databases 515, 570 and determine the values of the key figures of the financial instrument. In the example as shown in FIG. 5, the application logic 510 can retrieve information of the financial instrument from the database 515, determine the values of the key figures of the financial instrument, generate an XML file (or files in other file format) containing the data object as described herein, and send the file to the second application 555. The file can be sent by the outbound layer 520 using any file transfer protocols, for example, File Transfer Protocol (FTP), Trivial File Transfer Protocol (TFTP), Network File System (NFS) protocol, etc. Inbound layer 560 of the second application 555 can receive the file transferred from the first application 505. Applicant logic 565 can read the information in the file received and can store the file into the database 570.

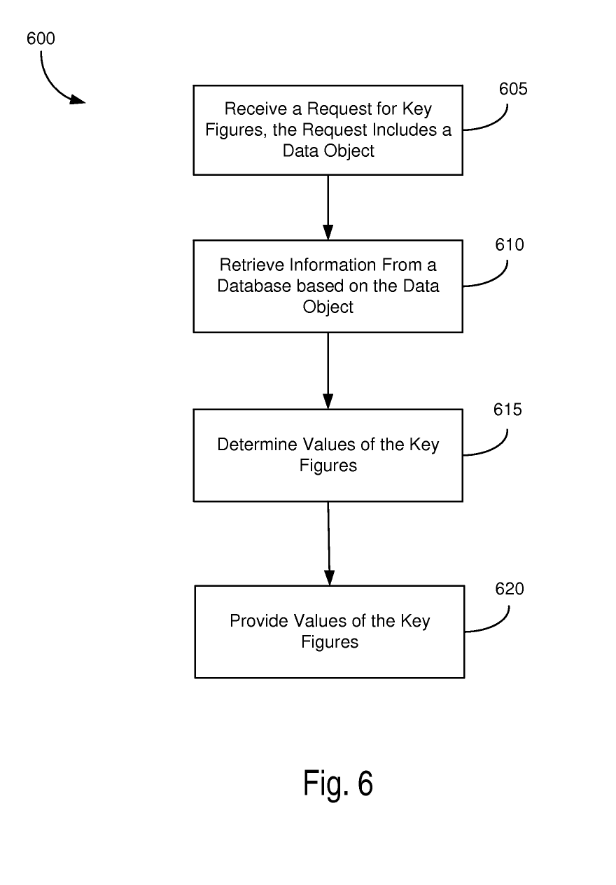

FIG. 6 illustrates a flow diagram depicting a process 600 of providing information of a financial instrument via a computer network. Process 600 includes receiving a request for obtaining one or more key figures of a financial instrument via the computer network from a computing device (BLOCK 605). For example, one or more processing circuits of a server can receive the request from a client computing device. The request may include a data object including a first identifier for identifying the financial instrument, a second identifier for identifying an entity owning the financial instrument, a third identifier for identifying a collection of specifications structuring a body of accounting records, a fourth identifier for identifying a fiscal year, a fifth identifier for identifying a category of the financial instrument, and a sixth identifier for identifying a posting period or an accounting period. The starting date of the posting period or the accounting period can be the same or later than the starting date of the fiscal year, and the ending date of the posting period or the accounting period can be the same or earlier than the ending date of the fiscal year.

Process 600 includes retrieving information associated with the financial instrument from a database based on the data object (BLOCK 610). For example, a server can query a database by specifying the attributes in the data object. For example, the query can include the identifier of the financial instrument, the identifier of the entity owning the financial instrument, the posting period, and the key figure that is requested to retrieve information associated with the financial instrument from the database.

Process 600 includes determining the values of the key figures of the financial instrument (BLOCK 615) based on the information retrieved from the database (BLOCK 610). For example, a server can determine the values of the key figures of the financial instrument. For example, if the key figure requested is an accounting balance key figure for a mortgage loan at Dec. 31, 2013, the balance of the mortgage loan at Dec. 31, 2013 can be calculated.

Process 600 includes providing the values of the key figures of the financial instrument via the computing network to the computing device (BLOCK 620). For example, a server can provide the values of the key figures of the financial instrument to the computing device. In one embodiment, the server 120 can generate an XML document which includes the values of the key figures determined by the server. The XML document can be transmitted to the computing device via the network.

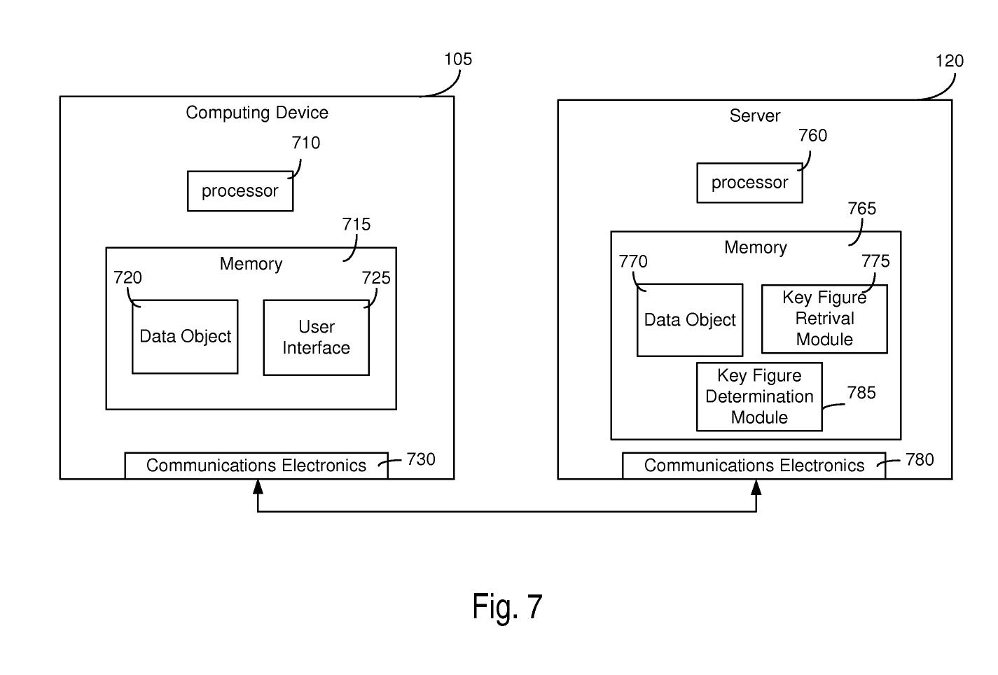

Referring now to FIG. 7, a more detailed block diagram of computing device 105 and server 120 is shown, according to an exemplary embodiment. Computing device 105 and server 120 are each shown to include a processor or processing circuit 710, 760 and memory 715, 765. Processor or processing circuit 710, 760 may be implemented as a general purpose processor, an application specific integrated circuit (ASIC), one or more field programmable gate arrays (FPGAs), a CPU, a GPU, a group of processing components, or other suitable electronic processing components. Each memory 715, 765 may be or include one or more devices (e.g., RAM, ROM, Flash memory, hard disk storage, etc.) for storing data and/or computer code for completing and/or facilitating the various processes, layers, and modules described in the present disclosure. Memory 715, 765 may include volatile memory or non-volatile memory. Memory 715, 765 may include database components, object code components, script components, or any other type of information structure for supporting the various activities and information structures described in the present disclosure. Memory 715, 765 may be communicably connected to processor 710, 760, respectively, and includes computer code (e.g., via the modules stored in memory) for executing one or more processes described herein. Memory 715, 765 may be non-transient computer-readable media configured to store computer code modules for execution by the processor. Memory 715, 765 may store the data object described herein and may include a module or modules for appropriately completing each step of the processes described herein.

In the exemplary embodiment shown in FIG. 7, memory 715 of computing device 105 is shown to include a data object 720 and an user interface application 725 (e.g., user interface as described in FIGS. 2 and 3). In the exemplary embodiment shown in FIG. 7, memory 765 of server 120 is shown to include a data object 770, a key figure retrieval module 775 which can be configured to retrieve information associated with the financial instrument from a database, and a key figure determination module 785 which can be configured to determine the values of the key figures of the financial instrument.

Computing device 105 includes communications electronics 730 and server 120 includes communications electronics 780. Communications electronics 730, 780 may include wired or wireless interfaces (e.g., jacks, antennas, transmitters, receivers, transceivers, wire terminals, Ethernet ports, WiFi transceivers, etc.) for conducting data communications between computing device 105 and server 120, and between computing device 105 and server 120 and other local or remote devices or systems of system 100.

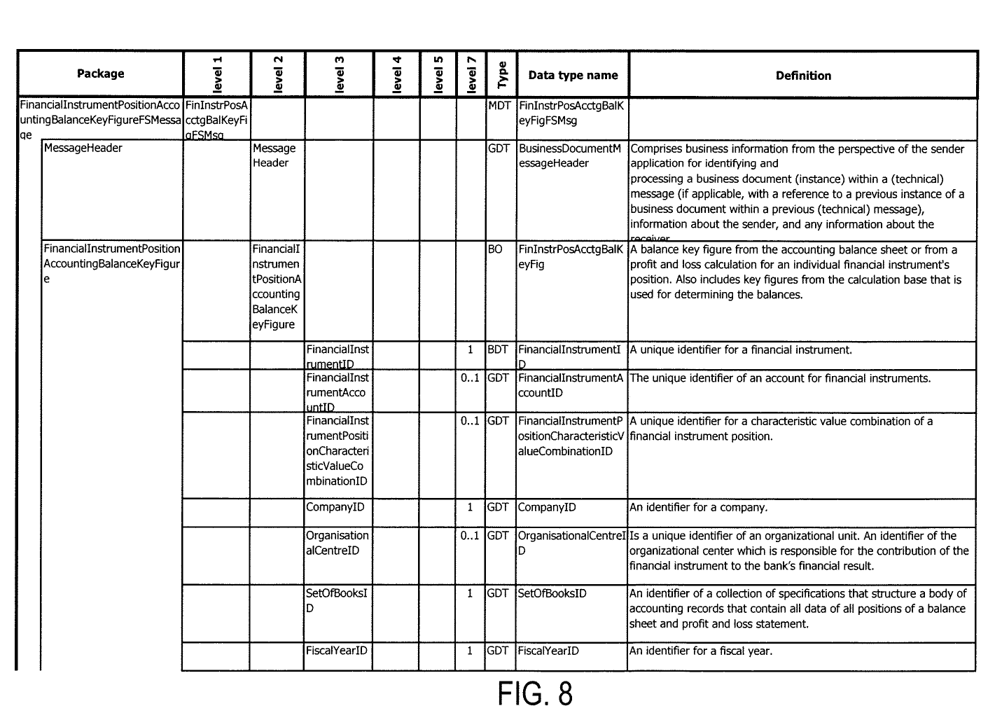

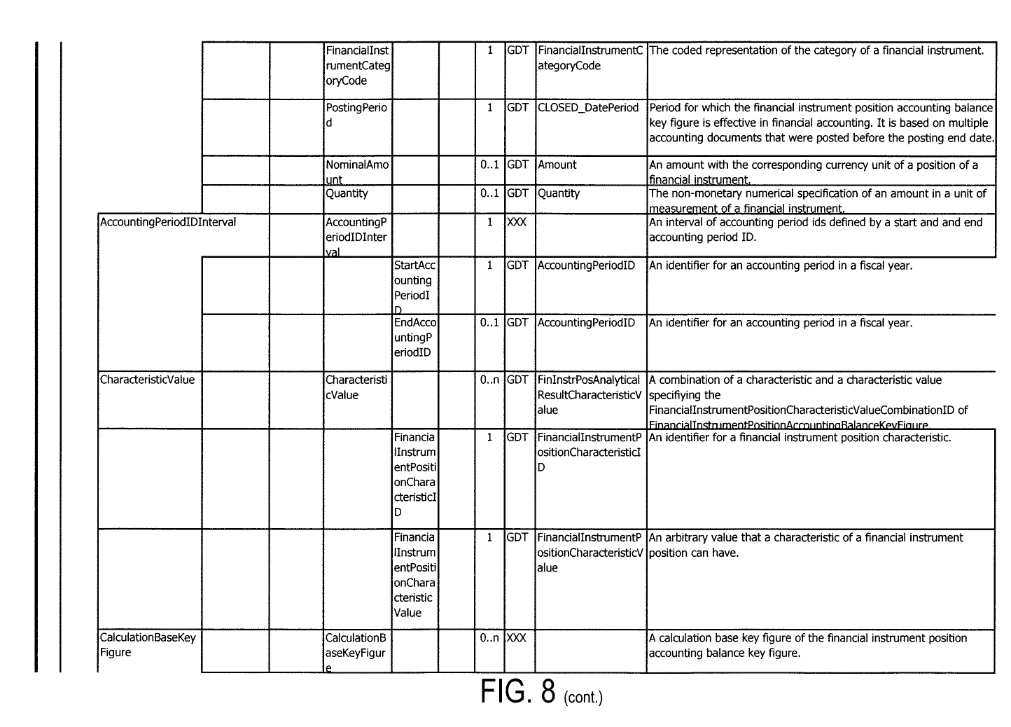

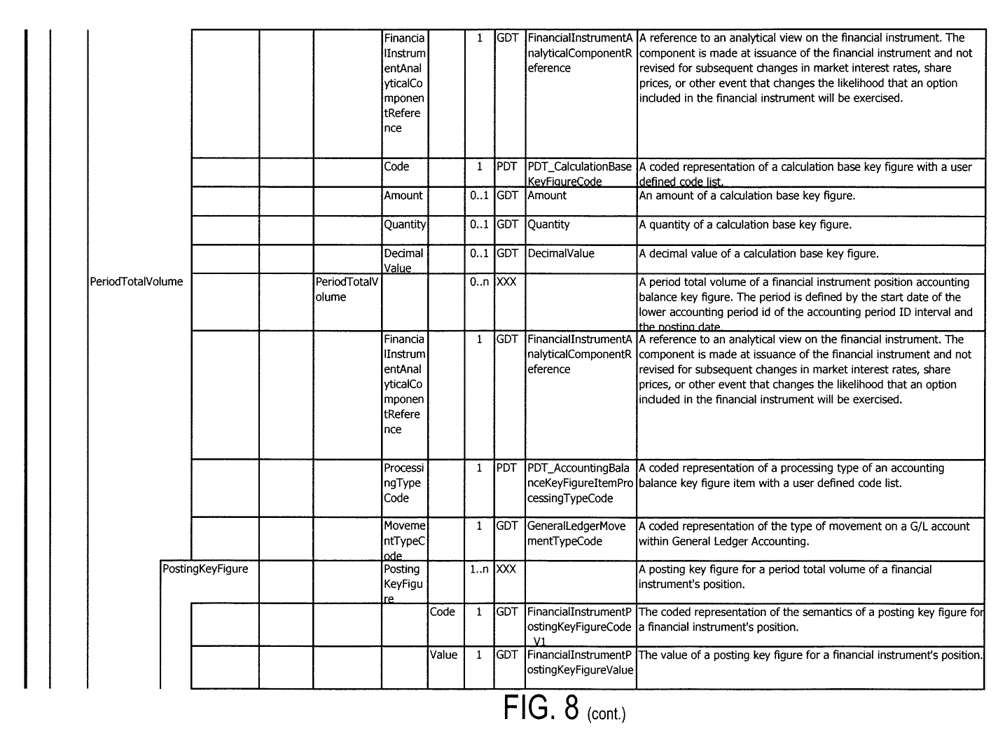

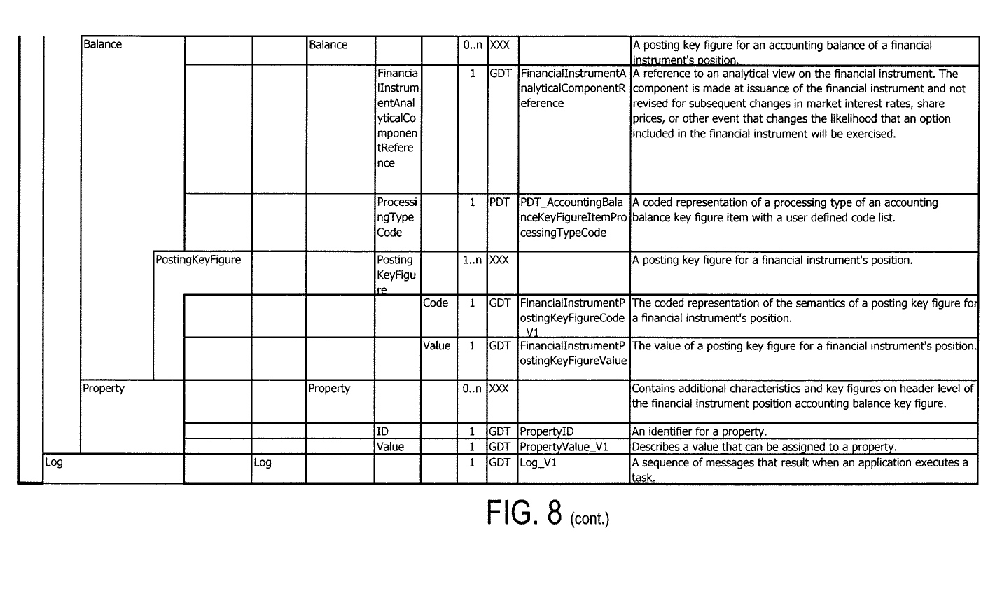

FIG. 8 illustrates an element structure for a financial instrument position accounting balance key figure, according to an illustrative embodiment. The element structure is shown to include various fields as described in the present disclosure. The element structure may be stored in, for example, memory 765 of the server 120 or memory 715 of the computing device 105. The element structure may be used to create the element structures as shown in FIGS. 2B and 3B. For example, upon receipt of a query from a user, computing device 105 may retrieve the data structure shown in FIG. 8 and use the data structure to create the element structure as shown in FIG. 2B. Likewise, upon generation of a response to a query, server 120 may retrieve the data structure shown in FIG. 8 to create the element structure of FIG. 3B. The element structure of FIG. 8 is shown to include various attributes such as a financial instrument position accounting balance key figure, an accounting period ID interval, characteristic values, calculation base key figure, period total volume, and balance attributes, as described above.

The construction and arrangement of the elements as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. The elements and assemblies may be constructed from any of a wide variety of materials that provide sufficient strength or durability, in any of a wide variety of colors, textures, and combinations. Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A computer-implemented method of providing information of a financial instrument via a computer network, comprising:
receiving, by at least one processing circuit, a request for obtaining one or more key figures of the financial instrument via the computer network from a computing device, wherein the request comprises a data object comprising:
a first identifier identifying the financial instrument,
a second identifier identifying an entity owning the financial instrument,
a third identifier identifying a collection of specifications structuring a body of accounting records,
a fourth identifier identifying a fiscal year,
a fifth identifier identifying a category of the financial instrument, and
a sixth identifier identifying a posting period or an accounting period, wherein a starting date of the posting period or the accounting period is same or later than a starting date of the fiscal year, and an ending date of the posting period or the accounting period is same or earlier than an ending date of the fiscal year;
determining, by the at least one processing circuit, one or more values of the one or more key figures of the financial instrument based at least in part on the data object; and
providing, by the at least one processing circuit, the one or more values of the one or more key figures of the financial instrument via the computing network to the computing device.

2. The method of claim 1, wherein the request comprises a request message, the request message comprising a message header and a payload, the payload comprising the data object, further comprising:
providing the one or more values of the one or more key figures of the financial instrument in a response message, the request message comprising a message header and a payload, the payload comprising the one or more values.

3. The method of claim 1, further comprising:
retrieving information associated with the financial instrument from a database based on the data object; and
determining the one or more values of the one or more key figures of the financial instrument based on the information retrieved from the database.

4. The method of claim 1, wherein the data object is stored and transmitted using a first XML document, further comprising:
generating a second XML document comprising the one or more values of the one or more key figures of the financial instrument; and
transmitting the second XML document to the computing device.

5. The method of claim 1, wherein the data object further comprises:
a characteristic value element comprising:
a financial instrument position characteristic identifier for identifying a financial instrument position characteristic, and
a financial instrument position characteristic value associated with the financial instrument position characteristic identifier; and
a calculation base key figure element comprising:
a financial instrument analytical component reference representing a reference to an analytical view on the financial instrument,
a calculation base code indicating a calculation base key figure with a user defined code list, and
at least one of an amount of a calculation base key figure, a quantity of a calculation based key figure, and a decimal value of a calculation base key figure.

6. The method of claim 1, wherein the data object further comprises:
a period total volume of a financial instrument position accounting balance key figure, comprising:
a financial instrument analytical component reference representing a reference to an analytical view on the financial instrument,
a processing type code indicating a processing type of an accounting balance key figure item,
a movement type code indicating a coded representation of a type of movement on a leger, and
a posting key figure for a period total volume of a financial instrument position.

7. The method of claim 1, wherein the data object further comprises:
a balance element indicating a posting key figure for an accounting balance of a financial instrument position, comprising:
a financial instrument analytical component reference representing a reference to an analytical view on the financial instrument,
a processing type code indicating a processing type of an accounting balance key figure item, and
a posting key figure for a financial instrument position.

8. The method of claim 1, wherein the data object further comprises:
a property element indicating additional characteristics and key figures on a header level of the financial instrument position accounting balance key figure and comprising an identifier for identifying a property and a property value describing a value that can be assigned to a property.

9. The method of claim 1, wherein the data object further comprises:
a financial instrument account identifier identifying an account for a financial instrument;
a financial instrument position characteristic value combination identifier identifying a characteristic value combination of a financial instrument position;
an organization center identifier identifying an origination unit responsible for the contribution of the financial instrument;
a nominal amount element indicating an amount with a corresponding currency unit of a position of the financial instrument; and
a quantity element indicating a non-monetary numerical specification of an amount in a unit of measurement of the financial instrument.

10. A system of providing information of a financial instrument via a computer network, comprising one or more processing circuits configured to:
receive a request for obtaining one or more key figures of the financial instrument from a computing device via the computer network, wherein the request comprising a data object comprises:
a first identifier identifying the financial instrument,
a second identifier identifying an entity owning the financial instrument,
a third identifier identifying a collection of specifications structuring a body of accounting records,
a fourth identifier identifying a fiscal year,
a fifth identifier identifying a category of the financial instrument, and
a sixth identifier identifying at least one of a posting period and an accounting period, wherein a starting date of the posting period or the accounting period is same or later than a starting date of the fiscal year, and an ending date of the posting period or the accounting period is same or earlier than an ending date of the fiscal year;
determine one or more values of the one or more key figures of the financial instrument based at least in part on the data object; and
provide the one or more values of the one or more key figures of the financial instrument via the computing network to the computing device.

11. The system of claim 10, wherein the request comprises a request message, the request message comprising a message header and a payload, the payload comprising the data object, and the one or more processing circuits are further configured to:
provide the one or more values of the one or more key figures of the financial instrument in a response message, the request message comprising a message header and a payload, the payload comprising the one or more values.

12. The system of claim 10, wherein the one or more processing circuits are further configured to:
retrieve data associated with the financial instrument from a database based on the data object; and
determine the one or more values of the one or more key figures of the financial instrument based on the data retrieved from the database.

13. The system of claim 10, wherein the data object is stored and transmitted using a first XML document from the computing device, and the one or more processing circuits are further configured to:
generate a second XML document comprising the one or more values of the one or more key figures of the financial instrument; and
transmit the second XML document to the computing device.

14. The system of claim 10, wherein the data object further comprises:
a characteristic value element comprising:
a financial instrument position characteristic identifier for identifying a financial instrument position characteristic, and
a financial instrument position characteristic value associated with the financial instrument position characteristic identifier; and
a calculation base key figure element comprising:
a financial instrument analytical component reference representing a reference to an analytical view on the financial instrument,
a calculation base code indicating a calculation base key figure with a user defined code list, and
at least one of an amount of a calculation base key figure, a quantity of a calculation based key figure, and a decimal value of a calculation base key figure.

15. The system of claim 10, wherein the data object further comprises at least one of:
a period total volume of a financial instrument position accounting balance key figure;
a balance element indicating a posting key figure for an accounting balance of a financial instrument position; and
a property element indicating additional characteristics and key figures on a header level of the financial instrument position accounting balance key figure and comprising an identifier for identifying a property and a property value describing a value that can be assigned to a property,
wherein the period total volume element comprises:
a financial instrument analytical component reference representing a reference to an analytical view on the financial instrument,
a processing type code indicating a processing type of an accounting balance key figure item,
a movement type code indicating a coded representation of a type of movement on a leger, and
a posting key figure for a period total volume of a financial instrument position;
wherein the balance element comprises:
a financial instrument analytical component reference representing a reference to an analytical view on the financial instrument,
a processing type code indicating a processing type of an accounting balance key figure item, and
a posting key figure for a financial instrument position.

16. The system of claim 10, wherein the data object further comprising:
a financial instrument account identifier identifying an account for a financial instrument;
a financial instrument position characteristic value combination identifier identifying a characteristic value combination of a financial instrument position;
an organization center identifier identifying an origination unit responsible for the contribution of the financial instrument;
a nominal amount element indicating an amount with a corresponding currency unit of a position of the financial instrument; and
a quantity element indicating a non-monetary numerical specification of an amount in a unit of measurement of the financial instrument.

17. A non-transitory computer readable medium having machine instructions stored therein, the instructions being executed by one or more processors to cause the one or more processors to perform operations comprising:
providing a data object associated with one or more key figures of a financial instrument, the data object comprising:
a first identifier identifying the financial instrument;
a second identifier identifying an entity owning the financial instrument;
a third identifier identifying a collection of specifications structuring a body of accounting records;
a fourth identifier identifying a fiscal year;
a fifth identifier identifying a category of the financial instrument; and
a sixth identifier identifying at least one of a posting period and an accounting period, wherein a starting date of the posting period or the accounting period is same or later than a starting date of the fiscal year, and an ending date of the posting period or the accounting period is same or earlier than an ending date of the fiscal year.

18. The non-transitory computer readable medium of claim 17, wherein the data object further comprises:
a characteristic value element comprising:
a financial instrument position characteristic identifier for identifying a financial instrument position characteristic, and
a financial instrument position characteristic value associated with the financial instrument position characteristic identifier; and
a calculation base key figure element comprising:
a financial instrument analytical component reference representing a reference to an analytical view on the financial instrument,
a calculation base code indicating a calculation base key figure with a user defined code list, and
at least one of an amount of a calculation base key figure, a quantity of a calculation based key figure, and a decimal value of a calculation base key figure.

19. The non-transitory computer readable medium of claim 17, wherein the data object further comprises at least one of:
a period total volume of a financial instrument position accounting balance key figure;
a balance element indicating a posting key figure for an accounting balance of a financial instrument position; and
a property element indicating additional characteristics and key figures on a header level of the financial instrument position accounting balance key figure and comprising an identifier for identifying a property and a property value describing a value that can be assigned to a property,
wherein the period total volume element comprises:
a financial instrument analytical component reference representing a reference to an analytical view on the financial instrument,
a processing type code indicating a processing type of an accounting balance key figure item,
a movement type code indicating a coded representation of a type of movement on a leger, and
a posting key figure for a period total volume of a financial instrument position;
wherein the balance element comprises:
a financial instrument analytical component reference representing a reference to an analytical view on the financial instrument,
a processing type code indicating a processing type of an accounting balance key figure item, and
a posting key figure for a financial instrument position.

20. The non-transitory computer readable medium of claim 17, wherein the data object further comprises:
a financial instrument account identifier identifying an account for a financial instrument;
a financial instrument position characteristic vale combination identifier identifying a characteristic value combination of a financial instrument position;
an organization center identifier identifying an origination unit responsible for the contribution of the financial instrument;
a nominal amount element indicating an amount with a corresponding currency unit of a position of the financial instrument; and
a quantity element indicating a non-monetary numerical specification of an amount in a unit of measurement of the financial instrument.
